(19) United States
(12) Patent Application Publication
(10) Pub. No.: US 2004/0117232 A1
(43) Pub. Date: Jun. 17, 2004

(54) Timeliness rating

(76) Inventor: Pedro Luis Benitez, Boston, MA (US)

Correspondence Address: Pedro Benitez, 2 Willers Street, West Roxbury, MA, 02132, US

(21) Appl. No.: 10/318,938

(22) Filed: Dec. 16, 2002

(51) Int. Cl. G06F 17/60

(52) U.S. Cl. 705/9; 705/10

(57) ABSTRACT

The Construction Industry is one of the largest industries in the United States. Physical infrastructure (including but not limited to housing, hospitals, schools, highways, airports, railways, ports, factories, power plants, etc.) is the foundation of our modem society. One major characteristic of the Construction Industry is that many projects are delayed beyond their originally projected completion date. The “Timeliness Rating™” concept creates a simple and straightforward way to quantify project delays. It is simply the ratio of the actual project duration to the originally projected duration. This concept can be applied to any type and size of project, including non-construction projects. Some benefits of this concept are that all participants in a project will put their best efforts into achieving a “Timeliness Rating™” of 1.00 or less. Avoiding costly project delays can represent savings of billions of dollars annually to the U.S. economy. This concept is simple, objective, and quantifiable.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The “Timeliness Rating™” invention pertains to the Construction Industry and other industries. It is a method, process and procedure to measure the time that it took or will take to complete a construction project or other project types. It gives a rating that helps determine if a construction project or other type of project was or will be completed on, ahead or behind schedule.

### BRIEF SUMMARY OF THE INVENTION

One major characteristic of the Construction Industry is that many projects, for some reason or another, are delayed beyond the originally projected completion date. Some large-scale infrastructure projects, such as the Central Artery/Tunnel Project in Boston, can be up to several years behind schedule. One reason for this is that most construction projects are one-of-a-kind endeavors, with nothing similar having been built before, and thus it is extremely difficult, and sometimes impossible, to accurately predict the duration of a project.

How can project delays be controlled? Although most projects use any number of schedule management techniques, such as bar charts, CPM schedules, etc., many times there is a lack of commitment from the project stakeholders to follow these schedules and keep up the level of performance necessary to complete a project on schedule. The “Timeliness Rating™” concept creates a simple and straightforward way to quantify project delays. It is simply the ratio of the actual project duration to the originally projected duration, as follows:

$${}^{``} Timeliness {Rating}^{ ″} = \frac{Actual Project Duration}{Original Projected Duration}$$

A “Timeliness Rating™” of 1.00 would mean that a project was completed right on time. A “Timeliness Rating™” of less than 1.00 would mean that the project was completed ahead of schedule. A “Timeliness Rating™” of more than 1.00 would mean that the project was completed behind schedule. In other words, “Timeliness Rating™” will be a ratio indicating the time a project took to complete relative to its originally allotted time. The “Timeliness Rating™” of any project can thus be an objective measure to indicate how early or late a project would be at its completion.

Obviously, the original and actual durations shall both be in the same time units, be it days, weeks, months, etc. For accuracy, it is recommended that calendar days be used as the time unit.

### BRIEF DESCRIPTION OF THE SEVERAL VIEWS OF THE DRAWING

Not Applicable.

### DETAILED DESCRIPTION OF THE INVENTION

The Construction Industry is one of the largest industries in the United States. It accounts for between 5% and 10% of the Gross National Product (GNP) on a typical year. The benefits the Construction Industry brings to the overall well being of the nation, both economically and socially, are evident to anyone. Everyone knows how important housing, hospitals, schools, highways, airports, railways, ports, factories, power plants, and infrastructure in general, are for the efficient functioning on a daily basis of government, businesses, institutions, and private citizens in general. It can be said that physical infrastructure is the foundation of our modem society.

However, the Construction Industry continues to be one of the most backward and innovation-averse industries in the nation. In many ways, we continue to build things the same way we were building them decades, or even centuries ago. Another fact is that the use of information technology continues to lag behind in the Construction Industry relative to other industries.

One major characteristic of the Construction Industry is that many projects, for some reason or another, are delayed beyond the originally projected completion date. Some large-scale infrastructure projects, such as the Central Artery/Tunnel Project in Boston, can be up to several years behind schedule. One reason for this is that most construction projects are one-of-a-kind endeavors, with nothing similar having been built before, and thus it is extremely difficult, and sometimes impossible, to accurately predict the duration of a project.

Whose fault is this? Although the different participants in a construction project, be it Architects, Engineers, Construction Managers, General Contractors, Subcontractors, or Owners, tend to blame each other for project delays, the truth is usually each and every participant is at least partly responsible for a portion of the overall delay in any project. How can project delays be controlled? Although most projects use any number of schedule management techniques, such as bar charts, CPM schedules, etc., many times there is a lack of commitment from the project stakeholders to follow these schedules and keep up the level of performance necessary to complete a project on schedule. The “Timeliness Rating™” concept creates a simple and straightforward way to quantify project delays. It is simply the ratio of the actual project duration to the originally projected duration, as follows:

$${}^{``} Timeliness {Rating}^{ ″} = \frac{Actual Project Duration}{Original Projected Duration}$$

A “Timeliness Rating™” of 1.00 would mean that a project was completed right on time. A “Timeliness Rating™” of less than 1.00 would mean that the project was completed ahead of schedule. A “Timeliness Rating™” of more than 1.00 would mean that the project was completed behind schedule. In other words, “Timeliness Rating™” will be a ratio indicating the time a project took to complete relative to its originally allotted time. The “Timeliness Rating™” of any project can thus be an objective measure to indicate how early or late a project would be at its completion.

Obviously, the original and actual durations shall both be in the same time units, be it days, weeks, months, etc. For accuracy, it is recommended that calendar days be used as the time unit.

How is the duration of a project measured? Most public and private projects have an official start date defined by a “Notice to Proceed” document. This document usually certifies a date when a project is to start. In addition, most of these projects have an initial Contract Completion Date. This date may be a predetermined calendar date defined in the project's Contract Agreement. Or this date may determined by a duration of calendar days, weeks, months, etc. to complete the project from “Notice to Proceed”. The actual duration of any given project would be the time between the “Notice to Proceed” date and the “Substantial Completion” date of the project. ‘Substantial Completion” of a project is defined as the level of completeness when the Owner or User of the facility can take-over and start making use of the facility. Generally speaking, a “Certificate of Beneficial Occupancy” or a “Certificate of Substantial Completion” issued by the Architect/Engineer and/or the pertinent local, state and/or federal authorities shall suffice as evidence that a project has reached “Substantial Completion”.

This concept can be applied industry-wide to any type and size of project. One of the benefits of the concept is that it rates the project only, so it is in all the individual parties' interest that the outcome of the project is a “Timeliness Rating™” of 1.00 or lower.

Regardless of which project participant was responsible for the delays, it is in everyone's interest that the project is completed on time. If one of the project participants is lagging behind, it would be more likely that the other participants will push and even assist them in recovering time.

The consequences of project delays will be highly undesirable to anyone. An Owner with a dismal “Timeliness Rating™” will face the rejection of the most qualified Architecture/Engineering/Construction (A/E/C) firms to participate on this Owner's projects. Similarly, any A/E/C firm with a bad “Timeliness Rating™” will likely be at a disadvantage during a selection process to participate on any given project. A good “Timeliness Rating™” would have the potential of becoming an important competitive advantage when competing for jobs.

We can only start to imagine some of the benefits of this concept: every Construction Industry participant will be eager to boast about a “Timeliness Rating™” of less than 1.00 in their websites and marketing brochures. Architects will do all they can to complete designs accurately and on time so construction can proceed expeditiously. Engineers will respond to Requests-For-Information (RFIs) promptly so as not to delay construction progress. General Contractors and Subcontractors will ensure that their means and methods are the most efficient, and will become even more creative and risk-tolerant in devising ways to shorten construction durations, without compromising safety and quality. Owners will expedite their bidding procedures, design approvals, and decision-making processes. And so on. The potential to revolutionize the industry may very well be beyond anyone's dreams.

Other benefits of this concept are that it is simple, objective, and quantifiable.

How can this concept be implemented? One option is as a government requirement to be reported for every construction project above a certain value. Another option would be a privately funded institute that would gather and maintain this information, which may be available for a fee to interested parties.

1. What I claim as my invention is the “Timeliness Rating™” concept, term and methodology to measure duration of construction projects and other type of projects. As the “Timeliness Rating™” concept has the potential of saving billions of dollars annually to the U.S. economy when implemented and followed, I claim ownership of this invention and the right to exclude others from making, using, offering to sell, selling, or importing into the Unites States the subject matter that is within the scope of protection granted by the patent.
